(19) United States
(12) Patent Application Publication
(10) Pub. No.: US 2015/0140643 A1
(43) Pub. Date: May 21, 2015

(54) BIOLOGICAL ODOR CONTROL SYSTEM

(71) Applicant: Integrity Municipal Systems, LLC, Poway, CA (US)

(72) Inventor: Roop C. Jain, Poway, CA (US)

(21) Appl. No.: 14/541,671

(22) Filed: Nov. 14, 2014

Related U.S. Application Data
(60) Provisional application No. 61/904,669, filed on Nov. 15, 2013.

(51) Int. Cl. B01D 53/85; B01D 53/86

(52) U.S. Cl. CPC B01D 53/85; B01D 53/8612; B01D 53/869; B01D 53/8634
USPC 435/266; 435/299.1

(57) ABSTRACT

A biological odor control system includes a vessel and a nutrient tank mounted and attached to an outer surface of the vessel such that the nutrient tank does not extend into a housing of the vessel. The vessel can include a housing, a gas inlet, a gas outlet, a first media bed positioned within the housing of the vessel, and an irrigation system adapted to provide moisture, nutrients, and/or mixtures thereof to the first media bed within the housing of the vessel. A vessel and method for treating odorous gas are also disclosed.

### BACKGROUND OF THE INVENTION

1. Field of the Invention

The present invention relates to biological odor control systems and methods of treating odorous gases with biological odor control systems.

2. Description of the Related Art

Removal of odorous compounds from influent gas streams is a major environmental concern. Typically, these odorous compounds are removed through chemical and physical processes using carbon media, such as activated carbon media. However, carbon has a limited life span and needs to be replaced regularly (at a relatively high cost). In addition, chemical scrubber systems may be used, e.g., for H₂S removal. Such systems use various expensive chemicals, such as sodium hydroxide and sodium hypochlorite, and are often difficult or expensive to operate and maintain.

As a result of these drawbacks, biological treatment processes have emerged as an alternative for purifying odorous gases. Biological treatment systems use micro-organisms, such as bacteria, to break down the odor-causing compounds found in influent gas streams. Further, biological treatment systems often utilize vessels to pack media and microorganisms for the treatment process. However, because biological treatment systems require irrigation devices and various' other components, these systems have a large footprint, and an inconvenient, complicated layout of controls, piping, and other components. In addition, the media and microorganisms used in current biological odor treatment systems can allow residual odorous compounds to pass through into the environment.

Thus, a need exists for an improved biological odor control (BOC) system that addresses the various above-described drawbacks and deficiencies associated with current and existing systems and processes.

### SUMMARY OF THE INVENTION

Accordingly, and generally, provided is an improved biological odor control system and method that addresses and/or overcomes various drawbacks and deficiencies associated with existing biological odor control systems and methods. Preferably, provided is an improved biological control system and method that exhibits a unique arrangement of components and resulting footprint at installation. Preferably, provided is an improved biological odor control system and method that utilize specified media and microorganisms, and/or processes.

In certain preferred and non-limiting embodiments or aspects, the present invention is directed to a biological odor control system that can include a vessel with a nutrient tank, water control panel, and an electrical control unit mounted onto an outer surface of the vessel. The nutrient tank can be mounted onto and attached to the outer surface of the vessel such that the nutrient tank does not extend into a housing of the vessel. The nutrient tank can also be monolithically formed to an outer surface of the vessel. The vessel can include a housing, a gas inlet, a gas outlet, a first media bed positioned within the housing of the vessel, and an irrigation system adapted to provide moisture, nutrients, and/or mixtures thereof to the first media bed. The first media bed can include an inert porous inorganic media and biological materials that facilitate the conversion and absorption of odorous compounds from a gas source. An unobstructed air flow chamber can be formed within the housing of the vessel. The gas inlet can include an exhaust fan adapted to draw odorous gas into the vessel, and the gas outlet can include an exhaust stack adapted to release deodorized gas into the environment. The gas outlet can also include an outlet fan.

In certain preferred and non-limiting embodiments or aspects, the biological materials of the first media bed can include a sulfur-oxidizing autotrophic microorganism. The sulfur-oxidizing autotrophic microorganism can be a bacteria selected from Thiobacillus thiooxydans, Thiobacillus thioparus, Thiobacillus intermedius, and/or combinations thereof. Further, the inorganic media of the first media bed can include expanded clay. In some embodiments, the vessel can also include a second media bed positioned within the housing that can adsorb odorous compounds from the gas source. The second media bed can include virgin activated carbon media, high H₂S capacity carbon media, media adapted to remove ammonia and amines, and/or mixtures thereof.

In certain preferred and non-limiting embodiments or aspects, the vessel further includes a deck. In some of these embodiments or aspects, the nutrient tank and exhaust fan are mounted onto an outer surface of the deck. A sump can also be positioned within the housing of the vessel. A drain adapted to release water and acidic products from the sump can be attached to the vessel. Further, the vessel can rest on a sloped surface to allow water and other liquids to run to the side opposite the deck.

The vessel can have various designs including, but not limited to, a rectangular cross-section. In some of these embodiments or aspects, the water panel, the electrical control unit, the exhaust fan, and/or the nutrient tank are mounted on a same side of the vessel for a more compact system. To protect the various components mounted on the vessel from the environment and damaging weather conditions, a weather cover can be placed over at least a portion of the vessel. In addition, at least one or more of the vessel, the nutrient tank, the exhaust fan, and electrical control unit can be made of a fiber reinforced plastic, or optionally, polypropylene.

In certain preferred and non-limiting embodiments or aspects, the biological odor control system can be pre-assembled off-site at a facility remote or away from a site where the system will be shipped. By providing a pre-assembled biological odor control system, quality control testing is assured, improper installation at a jobsite is avoided, and installation costs and time are reduced.

In certain preferred and non-limiting embodiments or aspects, the present invention is also directed to a method of treating odorous gases. The method can include: drawing odorous gas into a housing of a vessel; distributing gas into a first media bed positioned within the housing of the vessel, where the first media bed can include inert porous inorganic media and biological materials that facilitate the conversion and absorption of odorous compounds from a gas source; distributing moisture, nutrients, or a combination thereof from an irrigation system into the first media bed where the nutrients are distributed to the irrigation system from a nutrient tank mounted onto and attached to an outer surface of the vessel such that the nutrient tank does not extend into a housing of the vessel; and releasing deodorized gas, e.g., into the environment. In addition, the method can include releasing water and acidic products from a sump positioned within the housing of the vessel. Optionally, in some embodiments or aspects, the method can also include distributing gas into a second media bed that can adsorb odorous compounds from the gas source.

In certain preferred and non-limiting embodiments or aspects, the present invention is also directed to a vessel for treating odorous gas. The vessel can include the various embodiments or aspects mentioned above and described in detail herein.

### BRIEF DESCRIPTION OF THE DRAWINGS

FIG. 1 illustrates a perspective view of a first embodiment or aspect of a biological odor control system according to the principles of the present invention;

FIG. 2 illustrates a perspective view of a second embodiment or aspect of a biological odor control system according to the principles of the present invention;

FIG. 3 illustrates a side cross-sectional view of the biological odor control system of FIG. 1 with the top exhaust stack removed;

FIG. 4 illustrates a side cross-sectional view of the deck of the biological odor control system of FIG. 1 according to the principles of the present invention;

FIG. 5 illustrates a side view of a biological odor control system of a third embodiment or aspect according to the principles of the present invention;

FIG. 6 illustrates a top view of the biological odor control system of FIG. 5 according to the principles of the present invention;

FIG. 7 illustrates a front view of the design of components in a water panel of the biological odor control system according to the principles of the present invention;

FIG. 8 illustrates a side cross-sectional view of a biological odor control system of FIG. 1 with the top exhaust stack removed;

FIG. 9 illustrates a front view of an exhaust stack of the biological control system of FIG. 1 according to the principles of the present invention;

FIG. 10 illustrates a schematic of an operational design of the biological control system of FIG. 1 according to the principles of the present invention;

FIG. 11 illustrates a schematic of an operational design of the biological control system of FIG. 1 according to the principles of the present invention;

FIG. 12 illustrates a schematic of an operational design of the biological control system of FIG. 2 according to the principles of the present invention;

FIG. 13 illustrates a perspective view of a weather cover placed over a portion of the vessel of the biological odor control system according to the principles of the present invention;

FIG. 14 illustrates a perspective view of a weather cover placed over the outlet fan of FIG. 2 according to the principles of the present invention; and

FIG. 15 illustrates a perspective view of the internal spray piping design of the biological odor control system according to FIG. 1 of the principles of the present invention.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments or aspects of the invention. Hence, specific dimensions and other physical characteristics related to the embodiments or aspects disclosed herein are not to be considered as limiting.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

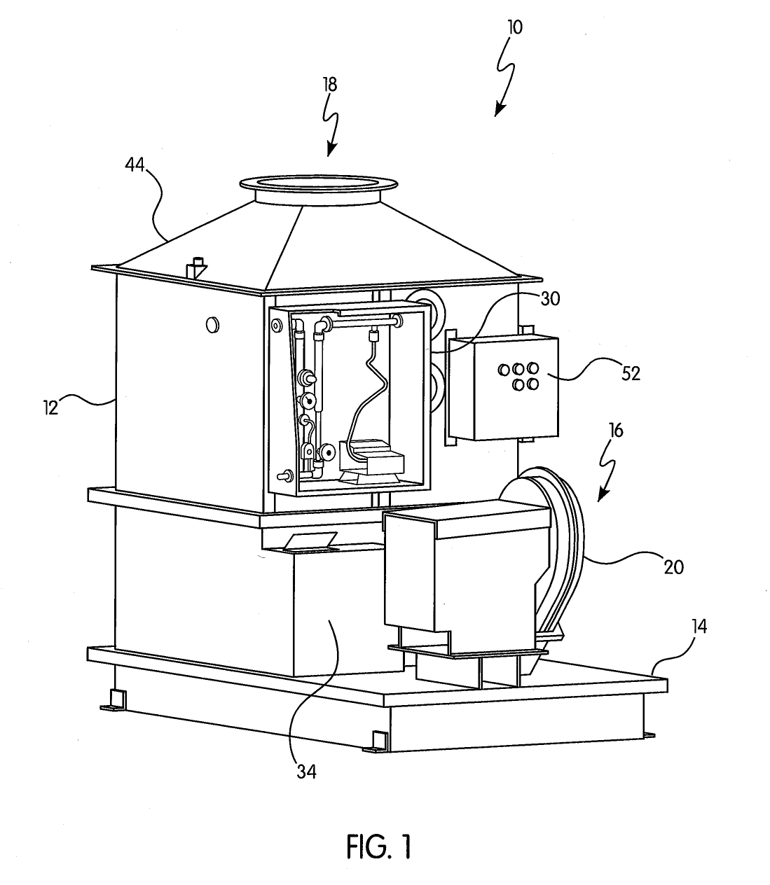

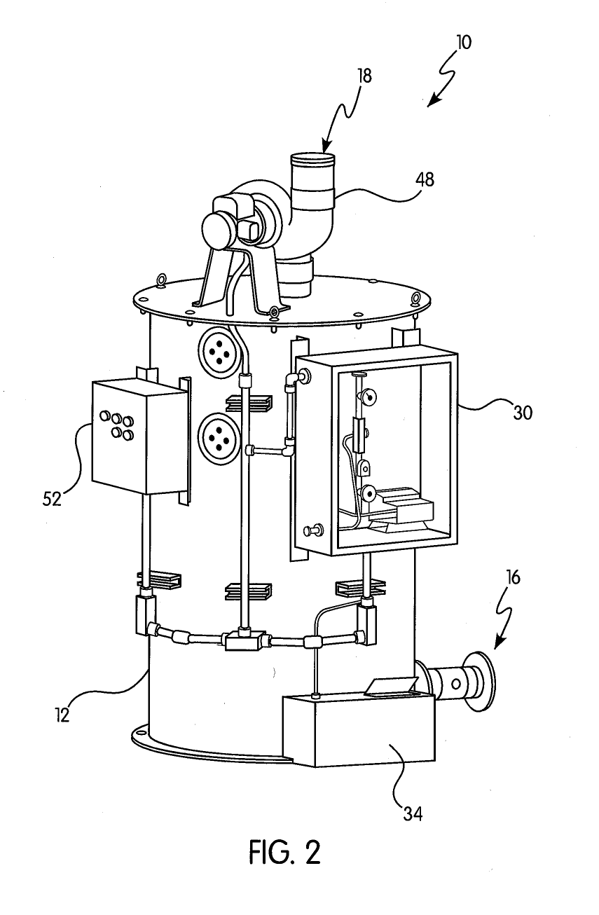

As indicated, in certain preferred and non-limiting embodiments or aspects, the present invention is directed to a biological odor control system 10. As shown in FIGS. 1 and 2, and according to certain preferred and non-limiting embodiment, the biological odor control system 10 can include a vessel 12. As shown in FIG. 1, the vessel 12 can have a rectangular cross-section. However, the shape of the vessel 12 is not so limited. For example, the vessel 12 can also have a cylindrical cross-section as shown in FIG. 2. The rectangular and cylindrical cross-sectional designs of the vessel 12 provide a smaller footprint than other designs allowing the vessel 12 to fit into smaller areas.

Further, unlike other existing systems, the vessel 12 does not include (i.e., is completely free of) lifting eyes. As used herein, the term “lifting eyes” refers to components fastened onto the outside portions of a vessel 12 that are used to lift the vessel 12 vertically and/or pull the vessel 12 horizontally. A non-limiting example of a lifting eye is an eyebolt with a first threaded end for fastening to a vessel 12 and a second end shaped in the design of a ring for engaging the eyebolt for lifting. It has been found that lifting eyes are often misused and present potential safety hazards. By excluding lifting eyes from the vessel 12, misuse of the vessel 12 and potential safety hazards are avoided.

As further shown in FIG. 1, the vessel 12 can have a deck 14 that extends out from the body of the vessel 12. The deck 14, e.g., an extended deck, includes a rigid platform where various components of the biological odor control system 10 can be mounted or formed onto an outer surface of the vessel 12. This allows for a more compact design and provides a smaller footprint requirement than current systems.

In certain preferred and non-limiting embodiments or aspects, at least a portion of the vessel 12, at least a portion of the deck 14, and/or other components described in detail below can be made of fiber reinforced plastic (FRP). As used herein, the term “fiber reinforced plastic” or FRP refers to a composite material made of a polymer matrix reinforced with fibers. A non-limiting example of a polymer matrix suitable for use in preparing at least a portion of the vessel 12 includes, but is not limited to, an epoxy vinyl ester resin. Epoxy vinyl ester resins that can be used are commercially available from Ashland, Inc. as Hetron® 922 and Derakane 411®. Other suitable epoxy vinyl ester resins are commercially available from AOC as Vipel F010®. As indicated, the polymer matrix can be reinforced with fibers. Non-limiting examples of reinforcing fibers include glass fibers. Suitable glass fibers that can be used include, but are not limited to, corrosion resistant borosilicate glass fibers. The resin materials of the polymer matrix can further include an inner veil of synthetic organic fibers, such as the inner veil commercially available from Precision Fabrics Group as NEXUS® 111-00010. The inner veil used in the corrosion layer can have thickness of at least 10 mils.

At least a portion of the vessel 12, the deck 14, and/or other components described in detail below can be fabricated through contact molding. As used herein, the term “contact molding” refers to a molding technique in which reinforcement fibers and resins are placed in a mold with cure taking place at room temperature with a catalyst/promoter system or under external influences such as heat. The vessel 12, extended deck 14, and/or other components described in detail below can be fabricated through contact molding in accordance with NBS PS 15-69, ASTM D3299-10, and ASTM D4097-01 (2010). Non-molded surfaces can be coated with resin incorporating paraffin.

Further, during fabrication of the vessel 12, the inner surface of all laminates can be resin rich and reinforced with an inner veil, such as NEXUS® 111-00010 described above, to form a corrosion liner. In certain embodiments or aspects, the interior corrosion liner can further include two layers of chopped strand mat. The corrosion liner can have a thickness of at least 100 mils. In addition, the structural laminate of the vessel 12 can include alternating layers of mat or chopped glass and a woven roving applied to reach a desired thickness. The exterior of the vessel 12 can also be coated with a white gel containing ultraviolet light inhibitors.

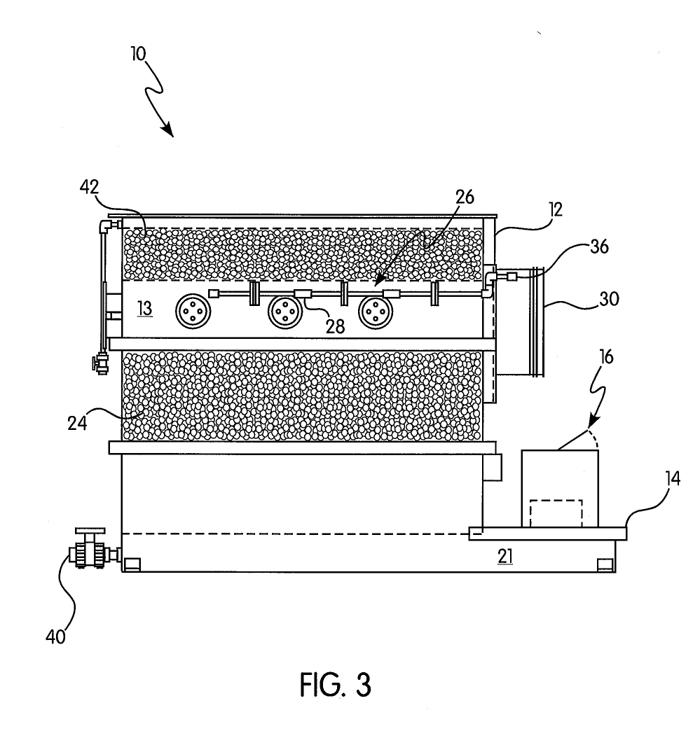

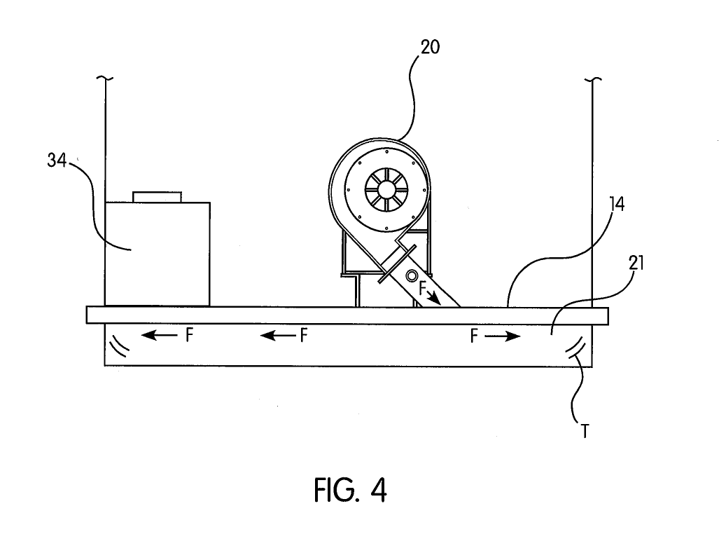

Referring again to FIG. 1, the vessel 12 can include a gas inlet 16 and a gas outlet 18. In certain embodiments or aspects, and as shown in FIG. 4, the gas inlet 16 includes an exhaust fan 20. The exhaust fan 20 is adapted to draw odorous gas from process areas into the housing 13 (see FIG. 3) of the vessel 12 for treatment. The exhaust fan 20 is sized and shaped to overcome pressure loss in the biological odor control system 10. The exhaust fan 20 can include a housing having a fan, an inlet, such as a flanged-type or slip-type inlet, and an outlet, such as a flanged-type or slip-type connection outlet. The exhaust fan 20 can include various other components including, but not limited to, an impeller, motor, belt drive, and the like. The components that make up the exhaust fan 20 can be made of FRP (e.g., the embodiment or aspect of FIG. 1), such as through a contact molding process as described above, or polypropylene (e.g., the embodiment or aspect of FIG. 2).

As shown in FIG. 1, the exhaust fan 20 can be mounted onto an outer surface of the deck 14 of the vessel 12. In such embodiments or aspects, referring to FIG. 3, an air chamber 21 is formed in a bottom portion of the housing 13 of the vessel 12 where odorous gas enters the biological odor control system 10 for treatment. Unlike other existing systems, the components that make up the biological odor control system 10 described herein are not positioned within the air chamber 21. As a result, the vessel 12 is designed to have an unobstructed air chamber 21 so gas can be distributed uniformly throughout the housing 13 of the vessel 12 without interruption. In certain embodiments or aspects, the air chamber 21 includes an unobstructed air plenum having a height of about 8 inches or more, which allows for uniform air distribution through the vessel 12. FIG. 4 illustrates odorous gas being drawn into the air chamber 21 of the vessel 12. Reference letter “F” illustrates the flow of gas into and through the air chamber 21 and reference letter “T” illustrates the areas of turbulence in the air chamber 21. As can be seen in FIG. 4, various components of the vessel 12, which are described in more detail below, are mounted and attached to the outer surface of the deck 14, such that the air chamber 21 is unobstructed for a uniform distribution of the odorous gas within the housing 13 of the vessel 12.

After odorous gas enters the housing 13 of the vessel 12, it is distributed to at least a first media bed 24 where pollutants and undesirable compounds are removed (see, for example, FIG. 3). The odorous gas is uniformly distributed into the first media bed 24 through the unobstructed air chamber 21. For instance, in certain preferred and non-limiting embodiments or aspects, the air chamber 21 includes an unobstructed air plenum having a height of about 8 inches or more for uniform distribution of the odorous gas into the first media bed 24.

The media of the first media bed 24 can be randomly distributed into the housing 13 of the vessel 12 to allow a low pressure drop. The media that makes up the first media bed 24 can be supported within the housing 13 of the vessel 12 by a support system that includes a screen. For example, in certain embodiments or aspects, a high density polyethylene (HDPE) or FRP support device having a polypropylene screen can be used to hold the media of the first media bed 24.

In certain preferred and non-limiting embodiments or aspects, the first media bed 24 can include an inert porous inorganic media and biological materials. The inert porous inorganic media can include a high capacity inorganic material for selectively growing the biological materials. The biological materials can include, but are not limited to, sulfur-oxidizing autotrophic microorganisms, such as bacteria. Non-limiting examples of bacteria that can be used as the sulfur-oxidizing autotrophic microorganisms include Thiobacillus thiooxydans, Thiobacillus thioparus, Thiobacillus intermedius, and/or combinations thereof. The first media bed 24 is resistant to acidic conditions and is efficient at removing hydrogen sulfide and other undesirable compounds. The first media bed 24 also has a high surface area per unit volume to optimize gas to liquid contact. Further, the media used with the first media bed 24 is porous and does not degrade or compact, allowing consistent, predictable and efficient performance for the life of the biological odor control system 10. In one preferred and non-limiting embodiment or aspect, the media used with the first media bed 24 is an expanded clay media.

To provide moisture to the first media bed 24, an irrigation arrangement or system 26 can be incorporated into the vessel 12. As shown in FIG. 3, the irrigation system 26 can include a distribution apparatus 28, such as, but not limited to, piping and spray nozzles. The irrigation system 26 can extend from the outside of the vessel 12 and into the housing 13 of the vessel 12 to provide the first media bed 24 with moisture to sustain growth of the microorganisms and remove toxic byproducts. In certain preferred and non-limiting embodiments or aspects, the moisture distributed over the first media bed 24 can include potable water, plant effluent water, or a combination thereof, provided that the water comprises a residual chlorine concentration of, in one preferred and non-limiting embodiment or aspect, less than 5 parts per million (ppm), in another preferred and non-limiting embodiment or aspect, less than 4 ppm, and in a further preferred and non-limiting embodiment or aspect, less than 3 ppm.

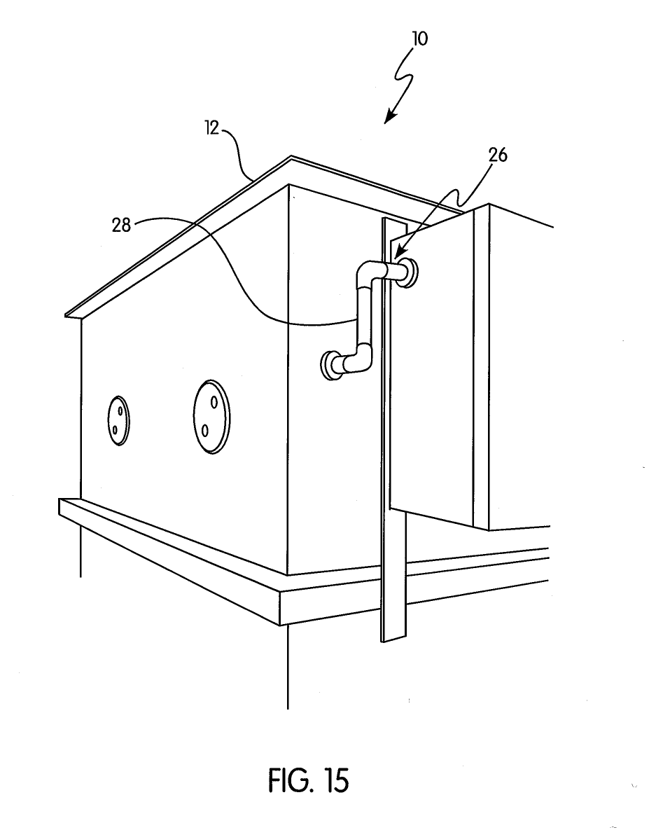

In certain embodiments or aspects, all or a substantial portion of the distribution apparatus 28 of the irrigation system 26 is positioned within the housing 13 of the vessel 12. For instance, the distribution apparatus 28 can enter at one end of the vessel 12 without being exposed at other areas of the vessel 12. FIG. 15 illustrates a perspective view of one embodiment or aspect of a portion of the distribution apparatus 28 of the irrigation system 26 entering the vessel 12 at one end. As shown in FIG. 15, only a small portion of the distribution apparatus 28 is located on the outside of the vessel 12 with the remaining portion located internally within the housing 13 of the vessel 12 (see, for example, FIG. 3). This internal configuration helps eliminate: vandalism; exposure of the irrigation system 26 to sunlight; and/or the potential of damaging the irrigation system 26 during shipping. The internal design also minimizes the dimensions of the biological odor control system 10.

In certain preferred and non-limiting embodiments or aspects, a water panel 30 can be mounted onto an outer surface of the vessel 12, as shown in FIGS. 1-3. The water panel 30 can be used to house piping and controls such as valves for the irrigation system 26 where frequency, duration, and start times of moisture distribution can be controlled. The amount of moisture distributed to the first media bed 24 will vary based upon airflow rate, gas odor strength, air temperature, and relative humidity of incoming air. The water panel 30 used with the present biological odor control system 10 has a compact, modular design with an uncomplicated and ordered layout of piping and controls. In certain preferred and non-limiting embodiments or aspects, the water panel has an enclosure size of about 24 inches by 24 inches by 12 inches (H×W×D).

In certain embodiments or aspects, nutrients can be distributed to the first media bed 24 to optimize growth of the sulfur-oxidizing microorganisms. Non-limiting examples of nutrients that can be added to the first media bed 24 include, but are not limited to, fertilizers. As used herein, the term “fertilizer” refers to a material or combination of materials which, when added to microorganisms, improves the rate of growth or health of the microorganisms. Non-limiting examples of ingredients that make up the fertilizers used as the nutrients include urea, nitrogen, phosphate, soluble squash, iron such as chelated iron, and/or mixtures thereof. The nutrients added to the first media bed 24 have been found to accelerate the acclimation process and improve hydrogen sulfide removal efficiency.

Referring to FIGS. 1 and 2, the nutrients can be stored in a nutrient tank 34. The nutrient tank 34 can be made of FRP such as through a contact molding process, as described above. The nutrient tank 34 can be mounted onto and attached to an outer surface of the vessel 12, such as onto the deck 14 as shown in FIG. 1. In certain embodiments or aspects, the nutrient tank 34 is molded onto an outer surface of the vessel 12. In some of these embodiments or aspects, the nutrient tank 34 is monolithically formed to an outer surface of the vessel 12. As used herein, “monolithically formed” refers to components or structures that are formed or cast as a single piece. Accordingly, in some embodiments or aspects, the vessel 12 and the nutrient tank 34 can be cast as a single piece where the nutrient tank 34 is positioned on an outside portion or surface of the vessel 12. The nutrient tank 34 is mounted and attached or molded on the outer surface of the vessel 12 such that the nutrient tank 34 does not enter the housing 13 of the vessel 12. As such, the nutrient tank 13 does not enter and disrupt the air chamber 21 and air flow of the vessel 12. Other systems commonly place at least a portion of the nutrient tank 34 within the housing 13 of the vessel 12, which interferes with air flow distribution through the vessel 12. Thus, as noted above, the present invention distributes air uniformly and, more efficiently, as compared to conventional systems. FIG. 4 illustrates an exhaust fan 20 and nutrient tank 34 mounted onto the deck 14 of a vessel 12 with odorous gas being drawn into the air chamber 21. Reference letter “F” illustrates the flow of gas into and through the air chamber and reference letter “T” illustrates the areas of turbulence in the air chamber 21. As can be seen in FIG. 4, the nutrient tank 34 is mounted and attached to the outer surface of the deck 14, such that the air chamber 21 is unobstructed.

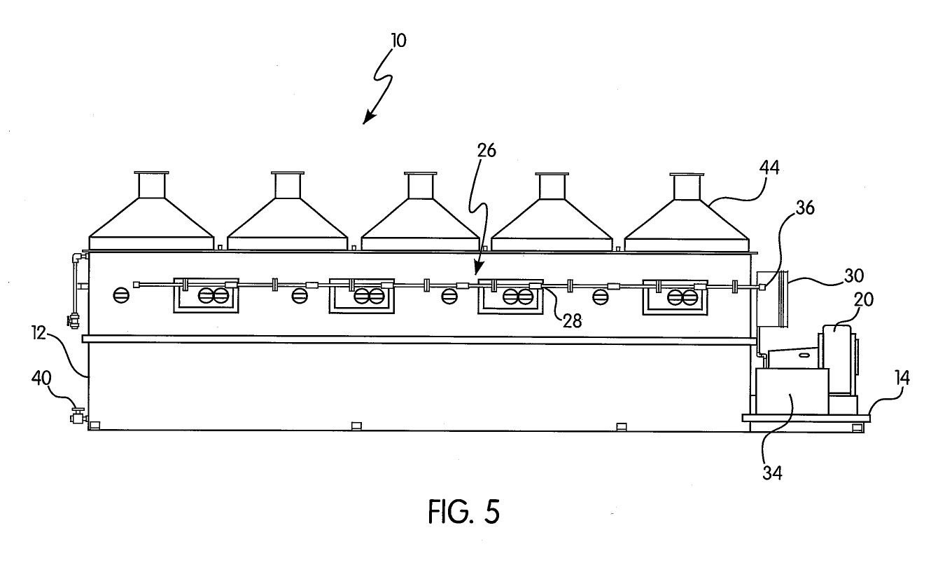

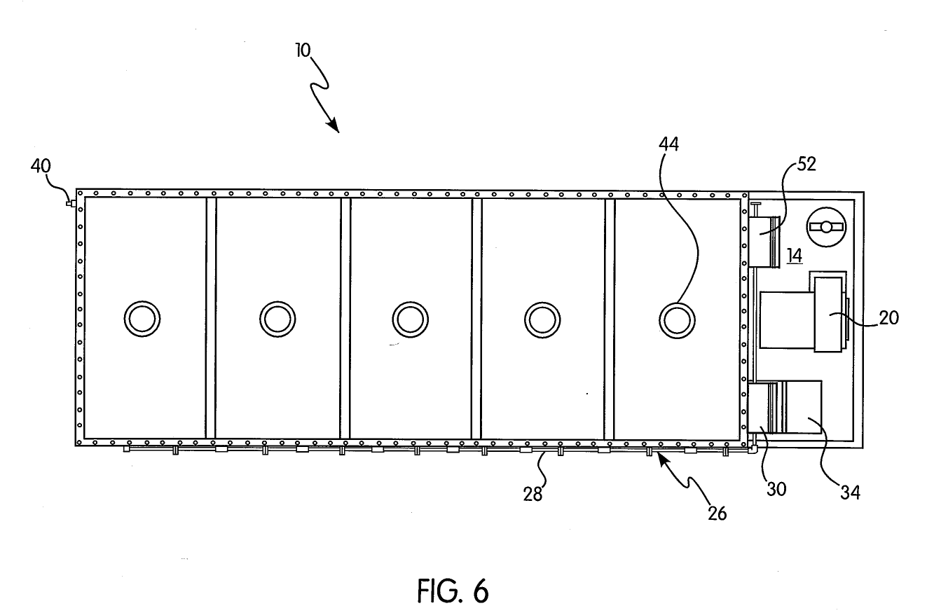

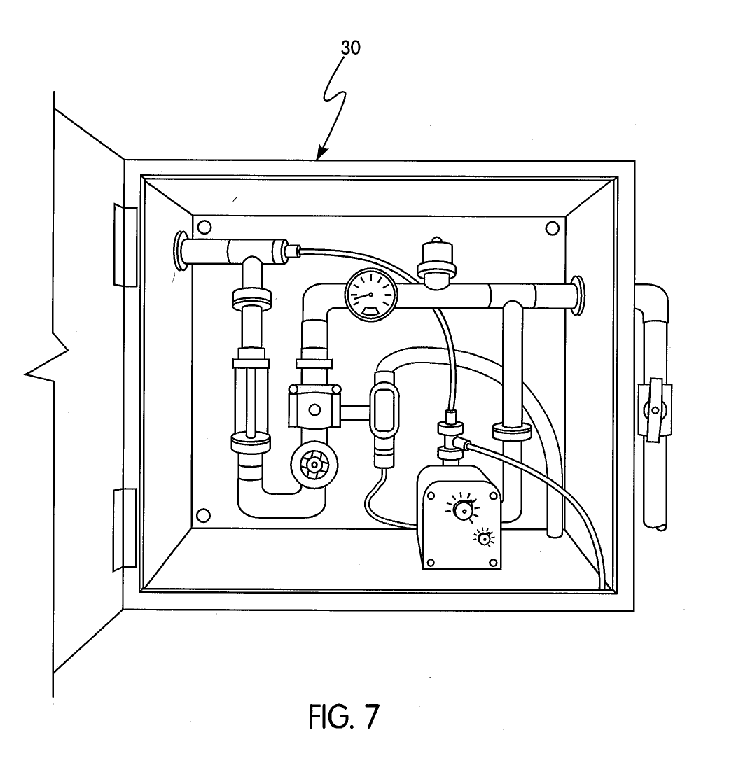

In certain preferred and non-limiting embodiments or aspects, nutrients from the nutrient tank 34 can be controlled by the water panel 30. Referring to FIG. 5, in some of these embodiments or aspects, the water panel 30 can include controls for a nutrient pump 36, such as a solenoid activated pump, that can distribute nutrients into the irrigation system 26 for distribution to the first media bed 24. FIG. 6 illustrates a top view of FIG. 5. As described above, in one preferred and non-limiting embodiment or aspect, the water panel 30 used with the present biological odor control system 10 has a compact, modular design. In certain preferred and non-limiting embodiments or aspects, the water panel 30 includes a dedicated water fill line for the nutrient tank 34 that allows for the distribution of nutrients into the irrigation system 26. The dedicated water fill line for the nutrient tank 34 can be positioned in an ordered, compact layout within the water panel 30, such as the water panel 30 having an enclosure size of about 24 inches by 24 inches by 12 inches as a non-limiting example. FIG. 7 illustrates the inside of a water panel 30 with an uncomplicated and ordered layout of piping and controls including the dedicated water fill line for the nutrient tank 34. The ordered layout shown in FIG. 7 allows for easy access and control over the irrigation system 26. Unlike other systems, the biological odor control system 10 of the present invention provides a beneficial compact or modular design.

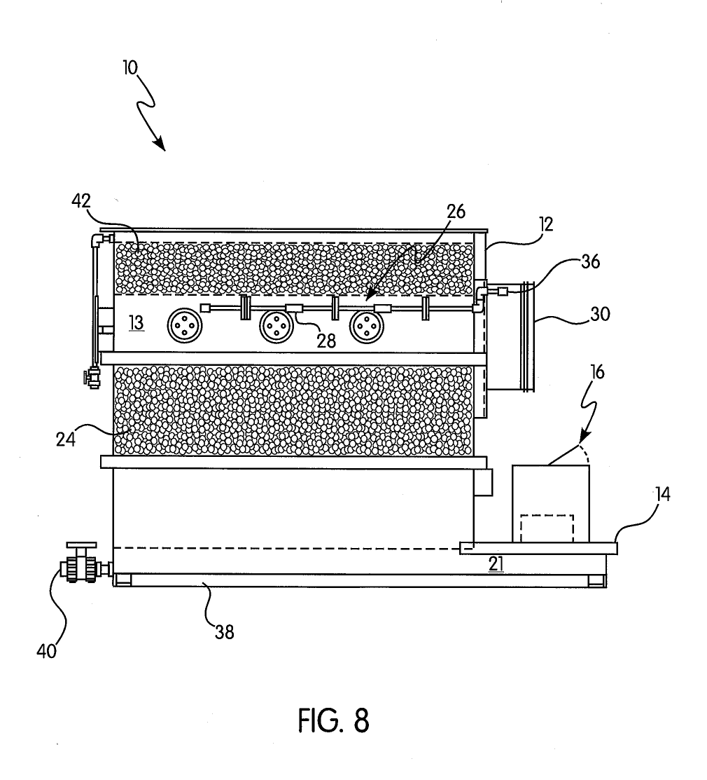

During operation of the irrigation system 26, moisture and/or nutrients are distributed over the first media bed 24 as odorous gas is being pushed up through the housing 13 of the vessel 12 counter-current to the direction of the moisture and/or nutrients. As gas passes over the moist media, hydrogen sulfide and other compounds dissolve into the water film on the surface of the media. These dissolved compounds become available to the microorganisms residing in the first media bed 24 for oxidation to release energy used by the microorganisms for growth. When nutrients are added, the nutrients can enhance and sustain the biological activity of the first media bed 24. Further, the water that passes through the first media bed 24 can rinse away the acidic byproducts. In certain preferred and non-limiting embodiments or aspects, and referring to FIG. 8, water and acidic byproducts washed from the first media bed 24 flow down into the bottom of the vessel where a sump 38 can be formed.

In certain preferred and non-limiting embodiments or aspects, a concrete pad on which the vessel rests is sloped, which allows water to run to the side opposite the deck 14 (and drain by gravity). As shown in FIG. 8, a drain 40 can be connected to the vessel 12 near the sump 38 to release water and acidic byproducts washed from the first media bed 24. The water and acidic byproducts can be returned to the process area where the odorous gas was drawn. During the draining process, odorous air is prevented from escaping through the drain 40. In some preferred and non-limiting embodiments or aspects, a water trap can be used with the drain 40 to prevent odors from escaping during a draining process.

In one preferred and non-limiting embodiment or aspect, the sump 38 is positioned substantially underneath the housing 13 of the vessel 12 in an area where the drain 40 is located. As discussed above, and in one preferred and non-limiting embodiment or aspect, the concrete pad is sloped from the fan area (on the deck 14) to the drain. This prevents water from entering or impacting the air chamber under the deck 14. This also allows the water to move to the side opposite the deck 14; again, where the drain 40 is located. The air flows from the exhaust fan 20 into the chamber 21 underneath the deck 14 and into the housing 13 bottom.

Optionally, in certain preferred and non-limiting embodiments or aspects, the vessel 12 also includes a second media bed 42 that is positioned in the housing 13 of the vessel 12 along with the first media bed 24 (see, for example, FIGS. 3 and 8). The second media bed 42 can prevent odorous compounds that passed through the first media bed 24 from entering the environment. The media that makes up the second media bed 42 can be supported within the housing 13 of the vessel 12 by a support system that includes a screen. For example, in certain preferred and non-limiting embodiments or aspects, a high density polyethylene (HDPE) or FRP support device having a polypropylene screen can be used to hold the media of the second media bed 42. Referring to FIGS. 3 and 8, the second media bed 42 can be positioned within the housing 13 of the vessel 12 so that odorous gas first passes through the first media bed 24. Any remaining pollutants and undesirable compounds will then enter the second media bed 42 where they can be adsorbed.

In certain preferred and non-limiting embodiments or aspects, the second media bed 42 includes or comprises a material that is adapted to adsorb and remove volatile organic compounds (VOCs), insoluble organic compounds, hydrogen sulfide, ammonia, amines, and/or mixtures thereof. Non-limiting examples of media material that can be used for the second media bed 42 includes virgin activated carbon media, high H₂S capacity carbon media, media adapted to remove ammonia) and amines, and/or mixtures thereof. Because most of the odorous compounds are absorbed by the first media bed 24, the second media bed 42 has an extended life span.

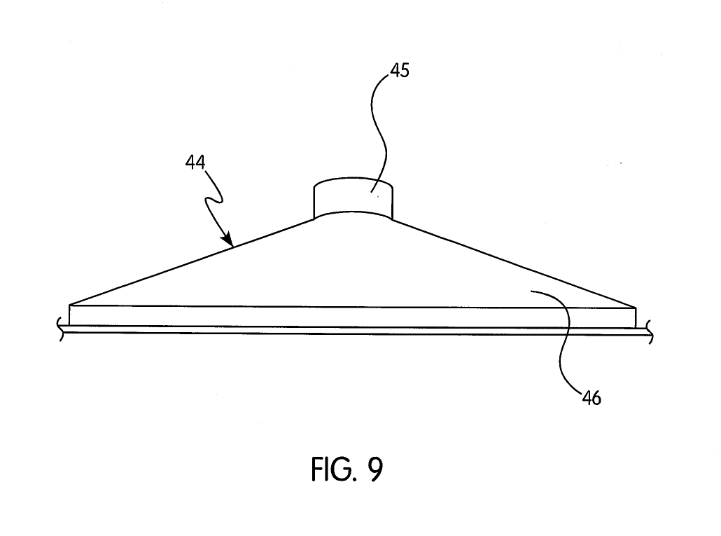

After odorous compounds are removed during the treatment process through the first media bed 24 and, optionally, the second media bed 42, deodorized gas can be released, such as into the environment, through the gas outlet 18. Referring to FIG. 1, and in certain preferred and non-limiting embodiments or aspects, the gas outlet 18 can include an exhaust stack 44 for collecting and releasing deodorized gas, such as into the environment. For instance, as shown in FIG. 9, the exhaust stack 44 can include a hood 46 with an outlet 45. The outlet 45 of the exhaust stack 44 is narrower than the opposite end of the exhaust stack 44 where the hood 46 is attached to the vessel 12. As such, the exhaust stack 44 can include a hood 46 that is angled to the outlet 45 of the exhaust stack 44. As treated gas enters the exhaust stack 44, the treated gas is collected within the hood 46, where it is released through the outlet 45 of the exhaust stack 44. The hood 46 of the exhaust stack 44 provides better air collection as compared to systems that utilize alternative designs, such as dome shaped exhaust systems. In some embodiments or aspects, as shown in FIG. 1, the gas outlet 18 includes one exhaust stack 44. Alternatively, the gas outlet 18 is composed of two or more exhaust stacks 44. For example, the biological odor control system 10 shown in FIGS. 5 and 6 includes five exhaust stacks 44. The exhaust stack 44 can be made of FRP such as through a contact molding process as described above. In certain embodiments or aspects, referring to FIG. 2, the gas outlet 18 includes an outlet fan 48 that also releases deodorized gas, such as into the environment.

Referring to FIGS. 1 and 2, an electrical control unit 52 can be mounted onto an outer surface of the vessel 12. As shown in FIG. 1, the electrical control unit 52 can be mounted on the same side of the vessel 12 where the water panel 30 and nutrient tank 34 are mounted. This arrangement or configuration decreases the footprint requirements and allows for easier operation of the biological odor control system 10. In certain preferred and non-limiting embodiments or aspects, the enclosure of the electrical control unit 52 can be made of FRP, such as through a contact molding process, as described above.

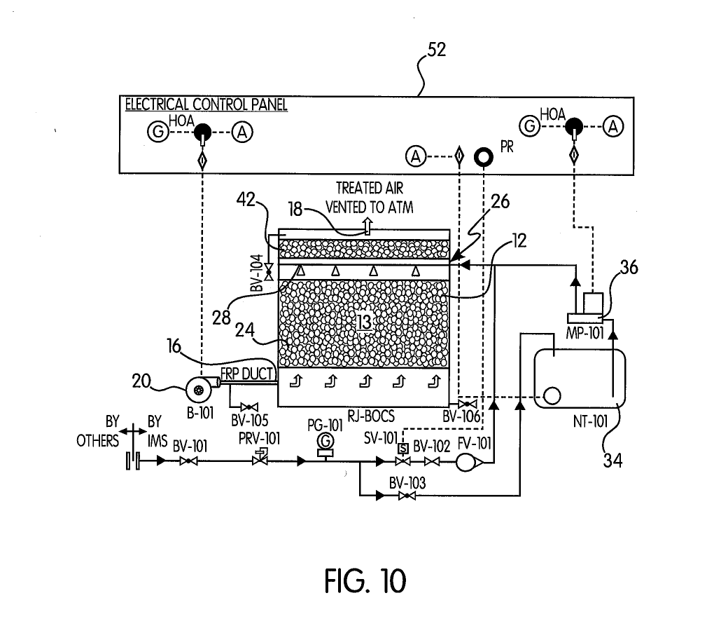

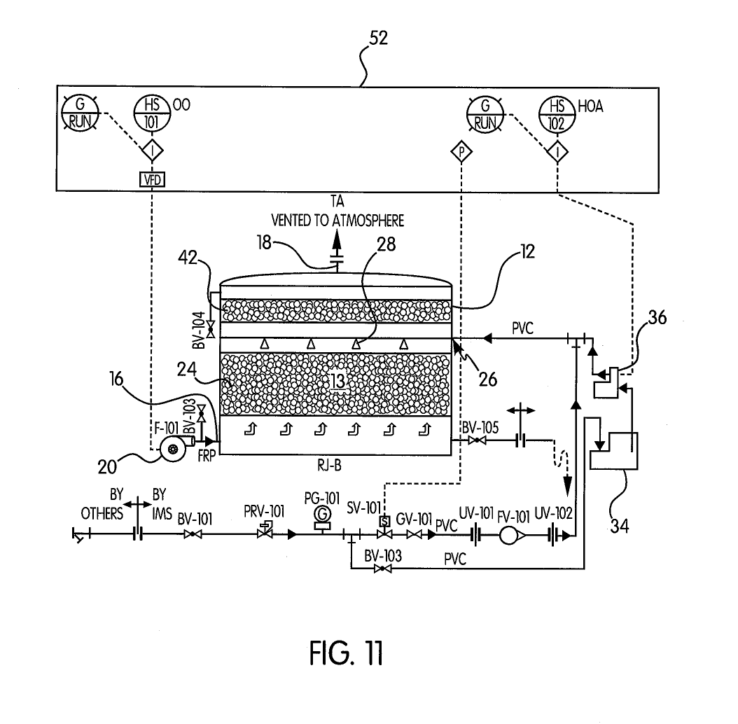

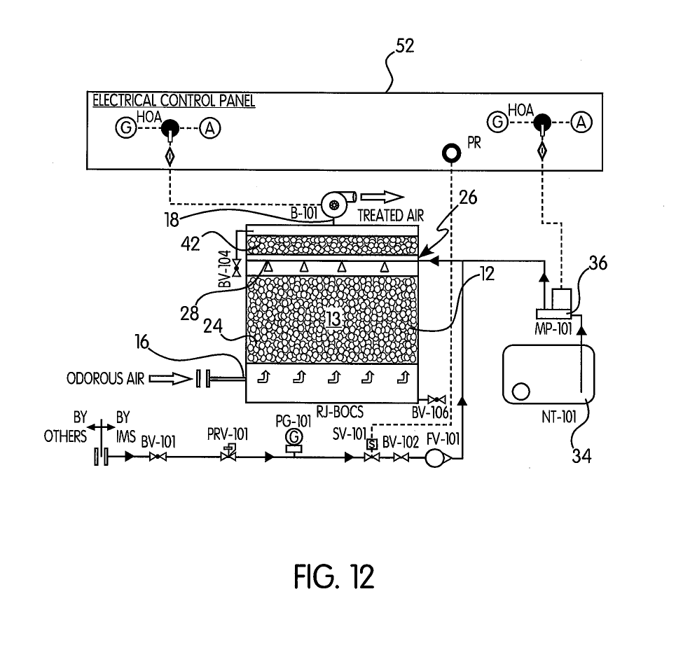

The electrical control unit 52 can control the processes and function of the entire biological odor control system 10. For example, the electrical control unit 52 can be used to control the exhaust fan 20 and detect when the fan 20 is malfunctioning. The electrical control unit 52 can also control the irrigation system 26 by controlling the solenoid valve, nutrient pump 36, and other controls housed in the water panel 30. FIG. 10 is a schematic of the operational design of one embodiment or aspect of the biological odor control system 10. As illustrated in FIG. 10, the electrical control unit 52 can be configured to control the exhaust fan 20, irrigation system 26, and nutrient pump 36. FIGS. 11 and 12 are schematics of the operational design of the electrical control unit 52, which can be configured to control the exhaust fan 20 and/or irrigation system 26 in both the side-fan-mounted embodiment or aspect (FIG. 11) and the top-fan-mounted embodiment or aspect (FIG. 12).

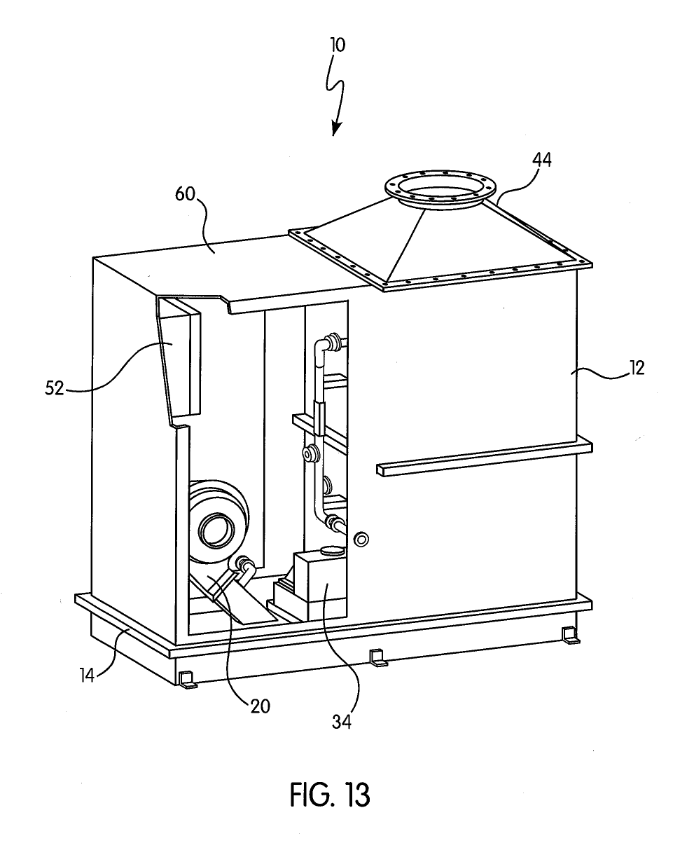

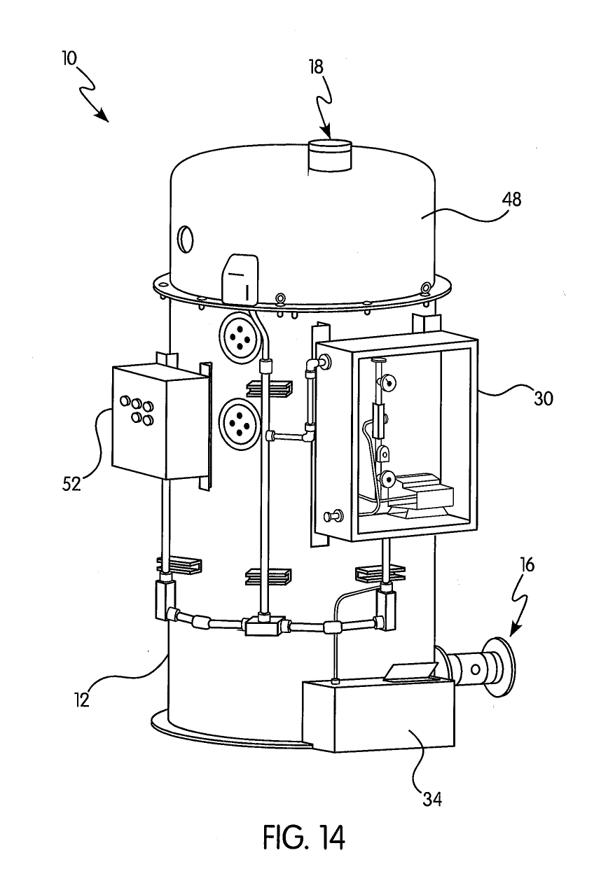

In certain preferred and non-limiting embodiments or aspects, referring to FIGS. 13 and 14, the biological odor control system 10 can have a weather cover 60. In some of these embodiments or aspects, the weather cover 60 can be placed over at least the deck 14 of the vessel 12 (see FIG. 13). As a result, the weather cover 60 protects components mounted onto an outer surface of the deck 14 from outdoor weather conditions. By using a weather cover 60 as shown in FIG. 13, the electrical control unit 52 can be mounted onto the weather cover 60. Further, in some embodiments or aspects, the piping and valves for the irrigation system 26 can be incorporated onto the vessel 12 and within the weather cover 60 without the need for a water panel 30. The weather cover 60 can also be designed to cover other portions of the vessel 12, thereby protecting components mounted on other areas of the vessel 12 from outdoor weather conditions. In some preferred and non-limiting embodiments or aspects, and as shown in FIG. 14, the weather cover 60 can be placed over at least a portion of an outlet fan 48.

In certain preferred and non-limiting embodiments or aspects, the biological odor control system 10 described herein can be pre-assembled prior to shipment. As used herein, “pre-assembled” refers to the assembly of various components of the biological odor control system 10 off-site at a facility remote or away from a destined site where the biological odor control system 10 will be shipped. For example, any combination of the vessel 12, exhaust fan 20, irrigation system 26, water panel 30, nutrient tank 34, exhaust stack 44, and electrical control unit 52 can be pre-assembled. Such assembly includes piping, wiring, and control testing. By providing a pre-assembled biological odor control system 10, quality control testing is assured, improper installation at a jobsite is avoided, and installation costs and time are reduced.

As described above, the various components of the biological odor control system 10 can be mounted directly onto an outer surface of the vessel 12. For example, the water panel 30, nutrient tank 34, exhaust fan 20, and/or electrical control unit 52 can all be mounted in close proximity to each other on an outer portion of the vessel 12. The resulting biological odor control system 10 is more compact than other systems with a small footprint allowing it to fit into small spaces. Further, by mounting the components onto an outer portion of the vessel 12, the vessel 12 exhibits an unobstructed, uniform distribution of air.

In addition, the electrical control unit 52 allows the biological odor control system 10 to be operated remotely with minimal operator maintenance and attention. Thus, water and nutrients can be automatically regulated with timers, automated controls, and the like. This ensures dependability of operation with minimized maintenance and downtime.

The biological odor control system 10 described herein also exhibits a hydrogen sulfide removal efficiency of at least 99%. The media used with the first bed 24 has a long life and requires minimal maintenance which lowers labor costs and system 10 downtime. The biological odor control system 10 also operates with consistent, low pressure drop across the media beds, which lowers operating power requirements and lowers operating costs.

While several embodiments or aspects of the invention were described in the foregoing detailed description, those skilled in the art may make modifications and alterations to these embodiments or aspects without departing from the scope and spirit of the invention. Accordingly, the foregoing description is intended to be illustrative rather than restrictive.

What is claimed is:

1. A biological odor control system comprising a vessel and a nutrient tank mounted onto and attached to an outer surface of the vessel such that the nutrient tank does not extend into a housing of the vessel, the vessel comprising:
a housing;
a gas inlet;
a gas outlet;
a first media bed positioned within the housing of the vessel, the first media bed comprising inert porous inorganic media and biological materials that facilitate the conversion and absorption of odorous compounds from a gas source; and
an irrigation system adapted to provide moisture, nutrients, and/or mixtures thereof to the first media bed within the housing of the vessel.

2. The system according to claim 1, wherein the nutrient tank is monolithically formed onto an outer surface of the vessel.

3. The system according to claim 1, further comprising a water panel mounted onto an outer surface of the vessel.

4. The system according to claim 1, further comprising an electrical control unit mounted onto an outer surface of the vessel.

5. The system according to claim 1, wherein the gas inlet comprises an exhaust fan adapted to draw odorous gas into the housing of the vessel.

6. The system according to claim 1, wherein the gas outlet comprises an exhaust stack.

7. The system according to claim 6, wherein the exhaust stack comprises an air collection hood.

8. The system according to claim 1, wherein the gas outlet comprises an outlet fan.

9. The system according to claim 1, wherein the biological materials of the first media bed comprise sulfur-oxidizing autotrophic microorganisms.

10. The system according to claim 9, wherein the sulfur-oxidizing autotrophic microorganism is a bacteria selected from Thiobacillus thiooxydans, Thiobacillus thioparus, Thiobacillus intermedius, and/or combinations thereof.

11. The system according to claim 9, wherein the inorganic media of the first media bed comprises expanded clay.

12. The system according to claim 1, further comprising a second media bed positioned within the housing of the vessel, the second media bed adapted to adsorb odorous compounds from the gas source.

13. The system according to claim 12, wherein the second media bed comprises virgin activated carbon media, high H₂S capacity carbon media, media adapted to remove ammonia and amines, or mixtures thereof.

14. The system according to claim 1, wherein the vessel further comprises a deck that extends out from the vessel.

15. The system according to claim 14, wherein the nutrient tank is mounted and attached to an outer surface of the deck.

16. The system according to claim 14, wherein the vessel rests on a sloped surface to allow water to run to the side opposite the deck.

17. The system according to claim 1, wherein the vessel is made of a fiber reinforced plastic.

18. The system according to claim 1, wherein the vessel further comprises a sump positioned within the housing of the vessel.

19. The system according to claim 18, wherein the vessel further comprises a drain adapted to release water and acidic products from the sump.

20. The system according to claim 1, further comprising a weather cover.

21. The system according to claim 20, further comprising an electrical control unit attached to the weather cover.

22. The system according to claim 21, further comprising a water panel and an electrical control unit, and wherein at least one of the following: the water panel, the electrical control unit, the gas inlet, the nutrient tank, or any combination thereof, are mounted on a same side of the vessel.

23. The system according to claim 1, further comprising an unobstructed air flow chamber positioned within the housing of the vessel.

24. The system according to claim 1, wherein the biological odor control system is pre-assembled off-site.

25. A vessel for treating odorous gas comprising:
a housing;
a gas inlet;
a gas outlet;
a first media bed positioned within the housing of the vessel, the first media bed comprising inert porous inorganic media and biological materials that facilitate the conversion and absorption of odorous compounds from a gas source;
an irrigation system adapted to provide moisture, nutrients, and/or mixtures thereof to the first media bed within the housing of the vessel; and
a deck that extends out from the vessel, the deck comprising an unobstructed air flow chamber.

26. The vessel according to claim 25, further comprising a second media bed positioned within the housing of the vessel, the second media bed adapted to adsorb odorous compounds from the gas source.

27. The vessel according to claim 25, wherein the vessel rests on a sloped surface to allow water to run to the side opposite the deck.

28. A method of treating odorous gas comprising:
a) drawing odorous gas into a housing of a vessel;
b) distributing gas into a first media bed positioned within the housing of the vessel, the first media bed comprising inert porous inorganic media and biological materials that facilitate the conversion and absorption of odorous compounds from a gas source;
c) distributing moisture, nutrients, and/or a combination thereof from an irrigation system into the first media bed, wherein the nutrients are distributed to the irrigation system from a nutrient tank mounted onto and attached to an outer surface of the vessel such that the nutrient tank does not extend into the housing of the vessel; and
d) releasing deodorized gas from the housing of the vessel.

29. The method of claim 28, further comprising distributing gas into a second media bed positioned within the housing of the vessel, the second media bed adapted to adsorb odorous compounds from the gas source.

30. The method of claim 28, further comprising releasing water and acidic products from a sump positioned within the housing of the vessel.

31. The method of claim 28, wherein the odorous gas is continuously drawn into an unobstructed air flow chamber positioned within the housing of the vessel by an exhaust fan.

32. The method of claim 28, wherein the vessel further comprises a water panel and an electrical control unit, and wherein at least one of the following: the water panel, the electrical control unit, the gas inlet, or any combination thereof, are mounted on an outside surface of the vessel.

33. The method of claim 28, wherein the biological materials of the first media bed comprise sulfur-oxidizing autotrophic microorganisms.

34. The method of claim 33, wherein the sulfur-oxidizing autotrophic microorganism is a bacteria selected from Thiobacillus thiooxydans, Thiobacillus thioparus, Thiobacillus intermedius, and/or combinations thereof.

35. The method of claim 28, wherein the inorganic media of the first media bed comprises expanded clay.

36. The method of claim 29, wherein the second media bed comprises a material selected from virgin activated carbon media, high H₂S capacity carbon media, media adapted to remove ammonia and amines, or mixtures thereof.

37. The method of claim 28, wherein the deodorized gas is released through an exhaust stack having a collection hood or an outlet fan.
